(19) United States
(12) Patent Application Publication
(10) Pub. No.: US 2006/0037037 A1
(43) Pub. Date: Feb. 16, 2006

(54) System and method for providing virtual video on demand

(76) Inventor: Tony Miranz, Palo Alto, CA (US)

Correspondence Address: SQUIRE, SANDERS & DEMPSEY L.L.P, 600 HANSEN WAY, PALO ALTO, CA, 94304-1043, US

(21) Appl. No.: 10/867,155

(22) Filed: Jun. 14, 2004

(51) Int. Cl. H04N 7/16; H04N 7/173

(52) U.S. Cl. 725/2; 725/100

(57) ABSTRACT

A set top box, comprises storage storing the lead portion of one or more objects prior to receiving a request for consumption of one of the one or more objects; a user interface for receiving a request for consumption of the requested object; a communication interface for communicating with a remote device, the remote device initiating delivery of a balance portion of the requested object upon request; and a control module coupled to the storage device, to the user interface and to the communication interface for initiating consumption of the lead portion, for requesting delivery of the balance portion, and for receiving at least part of the balance portion of the object during consumption of the object. The size of the lead portion may be computed to reduce the likelihood of consumption interruption. The size of the lead portion may be computed based on communication channel conditions. The size of the lead portion may computed based on the worst case channel condition over a predetermined window of time. The size of the lead portion may be computed by an algorithm accounting for download speed, object size, and playback time. The size of the lead portion may be computed so that the final bit of the balance portion of the object is expected to be received before the final bit is needed for consumption. The size of the lead portion may be computed based on object popularity. The size of the lead portion may be increased based on the expected demand of the object.

### BACKGROUND OF THE INVENTION

1. Field of the Invention

This invention relates generally to video on demand, and more particularly provides a system and method for providing virtual video on demand.

2. Description of the Background Art

Whether it is an elder telling a story by the fire or a family sitting in front of the television during dinner, humans have an innate need to hear stories and to be entertained. It is unbelievable how many televisions and/or radios each household has. In fact, it is estimated that every household has 2.3 televisions and that people watch television an average of five (5) hours per day. These statistics and human propensities motivate cable providers, satellite providers, video rental companies, Blockbuster Inc., NetFlix.com, etc. to invest millions of dollars to offer videos, television and movie broadcasts, premium movie channels, pay-per-view, etc. to customers.

Traditionally, each television viewer was satisfied to have four (4) or five (5) television channels offering a few shows and to go to the cinema for more exciting movie content. However, today's audiences have become more demanding, expecting so much more from television at home, including a large variety of more sophisticated dramas, comedies, adventures, horrors, etc. To satisfy this demand, the majority of television viewers subscribe to cable or satellite services, the basic service alone offering significantly more channels and premium broadcasts than regular television.

Still, customers remain unsatisfied. In response, cable and satellite services offer movie channel subscriptions. Each movie channel offers a limited number of relatively new releases of movie broadcasts at pre-selected times. A viewer can review movies lists and movie schedules, and plan to watch selected movies when they are offered. If the viewer turns on the television at the right time, the viewer can watch the movie from the beginning. Otherwise, the viewer may have to watch the movie starting from some other point. Alternatively, the viewer can record movies to watch at times more convenient to the viewer (whether using digital video recorders such as that offered by TiVo Inc. or traditional VCRs). Since the number of movies offered by these movie channels are limited, more disciplined viewers may record all desirable movies currently being provided and have to wait until additional titles come available. Since the number of movies offered on movie channels is limited and since the movies start at irregular times, movie channels do not effectively satisfy current customer demand.

Customer appeal of “video on demand” is well known. Generally, true video on demand can be characterized as instantaneous viewing of a movie (or other content) which may be selected from a list of preferably all movies available. Ideally, a server or set of servers will store all movies, will enable customers to select movies, and will stream the movies to the consumers while the customers view the movies without network interruption. However, given the many shortcomings of today's technology and network-related infrastructure, true video on demand is currently unavailable to the general public. Communication capacity and speed in satellite, cable and DSL networks are insufficient, unreliable, unpredictable and inconsistent. Because of the insufficient and inconsistent communication capacity and speed, if true video on demand were available, viewers on a system of today would have to settle for unwanted pauses and other erratic behavior. True video on demand will likely be unavailable to the general public for many years, available only after faster and significantly more reliable and predictable communication channels (e.g., fiber optics) are deployed and faster computing is developed. True VOD is offered today using specialized, reliable networks capable of delivering and maintaining high capacity and speed. Cable “On Demand” is one such service. On Demand provides the ability to instantly download movies for playback, but only if the user is connected to a high speed digital network and if the serving provider can support VOD. This service is not available over traditional broadband connections.

As a simple solution, cable and satellite providers offer pay-per-view, namely, a limited number of newer releases starting on average every half hour for about the price of a video rental. Even with pay-per-view, a customer has to select a movie from a limited set, and still has to wait until the broadcast begins. Further, in cases where the set top box does not support two way communication with the service provider, the customer has to inconveniently telephone a service to order the selected movie. Pay-per-view is a feeble solution to true video on demand.

Several cable and internet companies are considering other alternatives to true video on demand. One of the better alternative system of today enables a viewer to select, order, download and view a movie. However, because of slow download speeds and considerable movie size, the viewer has to wait significant time, e.g., one (1) to (2) hours, for the movie to download. Although in many ways better than pay-per-view, this option is still far from ideal. The solution makes customers wait a long time before receiving the movie, fails to give consumers immediate gratification, and fails to take advantage of impulsive nature of many purchasers.

Satellite providers specifically will have difficulty providing true video on demand or current alternatives because satellite communication offers no return path, i.e., offers only one-way communication from the satellite provider to the customer, and because satellite bandwidth which is sufficient for broadcast (i.e. point-to-multipoint) is insufficient for point-to-point communication. At this time, customers have no way to peruse movie options, request a movie, etc. without some two-way mode of communication. Because of the limited capabilities of satellite networks, satellite providers are at a substantial disadvantage to cable providers who can offer cable, internet broadband, voice over IP, and other network services.

Companies such as Blockbuster Inc. and Netflix, Inc. have created business models that attempt to give greater movie options to customers. However, Blockbuster requires customers to get off the sofa, get dressed, go to a hopefully local business establishment, select a movie (which is often unavailable), and return home before being able to start the movie. Netflix allows a customer to order movies from extensive lists, but mails the requested movies using traditional post. Customers have to wait at least several days before a requested movie is received. These two models do not offer anything “on demand.”

### SUMMARY

According to a first embodiment, the present invention provides a method, comprising storing a lead portion of an object on a set top box prior to receiving a request for consumption of the object; receiving a request for consumption of the object; initiating consumption of the lead portion; and receiving at least some of a balance portion of the object during consumption of the object. The object may include video, an electronic game, pure audio, text or other item. The set top box may store the lead portion of many objects.

The size of the lead portion may be computed periodically to reduce the likelihood of consumption interruption. The size of the lead portion may be computed based on communication channel conditions. The size of the lead portion may computed based on the worst case channel condition over a predetermined window of time. The size of the lead portion may be computed by an algorithm accounting for download speed, object size, and playback time. The size of the lead portion may be computed so that the final bit of the balance portion of the object is expected to be received before the final bit is needed for consumption. The size of the lead portion may be computed based on object popularity. The size of the lead portion may be increased based on the expected demand of the object.

According to another embodiment, the present invention provides a set top box, comprising storage storing a lead portion of an object prior to receiving a request for consumption of the object; a user interface for receiving a request for consumption of the object; a communication interface for communicating with a remote device, the remote device initiating delivery of a balance portion of the object upon request; and a control module coupled to the storage device, to the user interface and to the communication interface for initiating consumption of the lead portion, for requesting delivery of the balance portion, and for receiving at least part of the balance portion of the object during consumption of the object.

In yet another embodiment, the present invention provides a method, comprising storing an object; forwarding a lead portion of the object to a set top box; receiving a request for a balance portion of the object, the request received after the lead portion has been forwarded to the set top box; and forwarding the balance portion to the set top box. Forwarding may be accomplished by streaming the balance portion to the set top box.

In another embodiment, the present invention provides a system, comprising storage storing an object; and a distribution server for forwarding a lead portion of the object to a set top box, and for forwarding a balance portion of the object to the set top box after the lead portion has been forwarded to the set top box and after receiving a request from the set top box.

In yet another embodiment, the present invention provides a method comprising storing a lead portion of an object on a first server prior to receiving a request for consumption of the object, the first server being geographically proximate to a set top box; storing a balance portion of an object on at least one second server; receiving a request for consumption of the object by the set top box; requesting the lead portion to be forwarded from the first server to the set top box; initiating consumption of the lead portion; and receiving at least some of a balance portion of the object during consumption of the object.

In another embodiment, the present invention provides a method performed by a set top box manager, the method comprising storing an object; forwarding a lead portion of the object to a first server, the first server being geographically proximate to a set top box; receiving a request from the set top box for a balance portion of the object, the request received after the lead portion has been forwarded to the first server; and forwarding the balance portion to the set top box. The lead portion may be forwarded to the set top box via a request to the first server or a request to the set top box manager. The lead portion may be streamed from the first server during consumption or downloaded first before consumption. In either case, the size of the lead portion, the number of previews to initiate first, the wait time, etc. will be based on the variables discussed above and below, including communication channel conditions, object size, object popularity, final bit lead time, etc.

### BRIEF DESCRIPTION OF THE DRAWINGS

FIG. 1 is a block diagram illustrating an object partitioning and distribution network system in accordance with a first embodiment of the present invention.

FIG. 2 is a block diagram illustrating an object partitioning and distribution network system implementing dynamic cache updating, in accordance with an embodiment of the present invention.

FIG. 3 is a block diagram illustrating an object partitioning and distribution network system, in accordance with an embodiment of the present invention.

FIG. 4 is a block diagram illustrating details of the set top box of FIG. 3, in accordance with an embodiment of the present invention.

FIG. 5 is a block diagram illustrating details of the set top box manager, in accordance with an embodiment of the present invention.

FIG. 6 is a graphical representation of factors for periodically determining lead portion size, in accordance with an embodiment of the present invention.

FIG. 7 is a block diagram illustrating details of a computer system.

FIG. 8 is a block diagram of a business model for implementing an object partitioning and distribution system, in accordance with an embodiment of the present invention.

FIG. 9 is a flowchart illustrating a method of initializing a set top box into an object partitioning and distribution system, in accordance with an embodiment of the present invention.

FIG. 10 is a flowchart illustrating a method of modifying objects stored based on a user preference change.

FIG. 11 is a flowchart illustrating a method of modifying objects stored based on additional objects becoming available.

FIG. 12 is a flowchart illustrating a method of using an object partitioning and distribution system, in accordance with an embodiment of the present invention.

### DETAILED DESCRIPTION

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein. For example, it will be appreciated that many of the embodiments below are being described with reference to movies as objects for distribution and consumption. One skilled in the art will recognize that other embodiments will operate on other object types such as pure audio, text, games (including adventure games), application programs, etc.

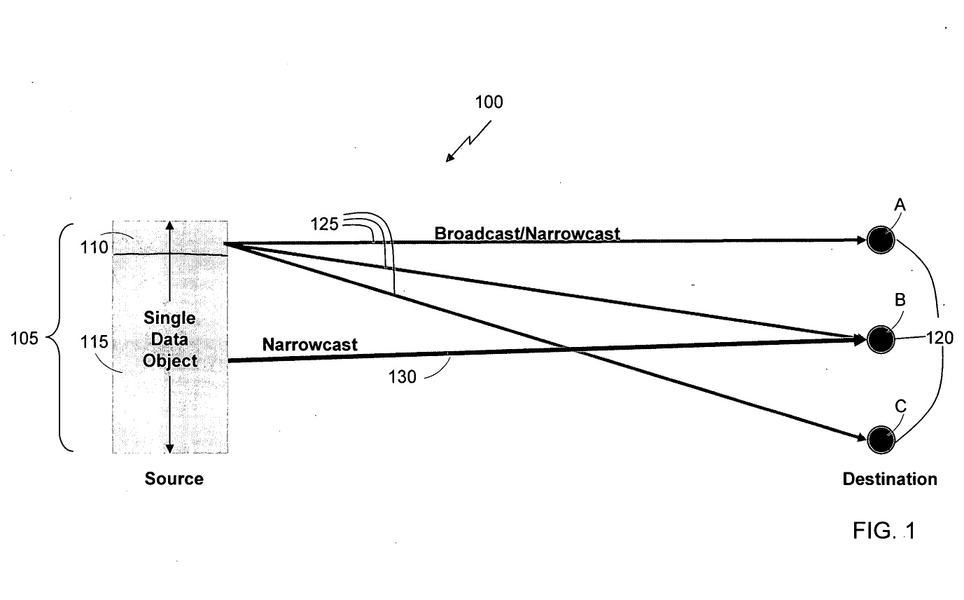

FIG. 1 is a block diagram illustrating the general concept of object partitioning and distribution in an object partitioning and distribution network system 100, in accordance with an embodiment of the present invention. As shown, object partitioning and distribution system 100 includes a single data object 105 (stored in computer storage medium) communicatively coupled via broadcast channels 125 and narrowcast channels 130 to set top boxes 120. The broadcast channels 125 may be satellite channels, cable channels, broadband channel, point-to-point channels, point-to-multipoint channels, combination of these channels, etc. The broadcast channels 125 can use any communication protocol such as RTP. The narrowcast channel 130 may be a satellite channel, a cable channel, a broadband channel, e.g., a DSL channel, or other channel whether point-to-point or point-to-multipoint. The narrowcast channels 130 may use any communication protocols such as TCP/IP, UDP/IP and/or any streaming protocol including real-time and non-real-time. Although the concept is being shown as including broadcast channels 125 and narrowcast channels 130, one skilled in the art will recognize that embodiments can be developed with either or other channel-types. Further, although object partitioning and distribution system 100 illustrates only one narrowcast channel 130, which happens to be coupled to set top box 120B, this embodiment will include multiple narrowcast channels to the many set top boxes 120. For simplicity, FIG. 1 illustrates only one narrowcast channel 130 going to one set top box 120, namely, to set top box 120B. Further, although object partitioning and distribution system 100 shows only one object 105, many objects 105 will preferably be available.

The single data object 105 is partitioned into portions, namely, into a lead portion 110 and a balance portion 115. Although the object 105 is described as partitioned into two portions, one skilled in the art will recognize that the object 105 may be partitioned into two or more portions. Further, one skilled in the art will recognize that the many portions can be stored on one or more computers. The object 105 may be a movie, a pure audio performance, an electronic book, a multimedia performance, an application program, a preview, game, or any other object. Preferably, the object 105 is one that is typically consumed continuously over time but takes more than an instant to download (whether because of download speeds or file size). The lead portion 110 represents a first data portion of the object 105, which is used for consumption of the first part of the object 105. The balance portion 115 represents the balance of the object 105, which can be used for consumption of the balance of the object 105. In a movie example, the lead portion 110 may represent the first fifteen (15) minutes of the movie, and the balance portion 115 may represent the remaining seventy-five (75) minutes. The term “consume” is intended to include watch, listen, perceive, and/or interact, etc.

The lead portion 110 of the data object 105 is sent, preferably over broadcast channels 125, to the set top boxes 120 for storage. By using broadcast channels 125, bandwidth over the narrowcast channels 130 may be preserved. This is especially true when more than one set top box 120 needs to receive all or part of the same lead portion 110. Since each set top box 120 stores a lead portion 110 of the data object 105, a user can begin consumption of the lead portion 110 immediately. Then, while the user is consuming the lead portion 110, the system 100 can download the balance portion 115 of the object 105 via a narrowcast channel 130 (or broadcast channel 125) to the appropriate set top box 120, thereby replenishing the data available for continuous user consumption of object 105. The size of the lead portion 110 is preferably selected so that user consumption of the entire object 105 goes uninterrupted despite fluctuations in the capacity and speed of connecting channels. The determination of the size of the lead portion 110 is described in detail below. As shown, a user of set top box 120B is currently consuming data object 105, while the set top box 120B continues to receive the balance portion 115.

One of the advantages of object partitioning and distribution can include immediate initiation of data object 105 consumption. In the movie example, the user need not wait until some specific time for the movie to begin. Further, since set top boxes 120 can store the lead portions 110 of several objects 105 (the exact number of lead portions 110 based on several factors including file size, disk space, object 105 demand, etc.), the user can select from a long list of objects 105. Still further, since entire objects 105 are not being stored on the set top boxes 120, a greater number of objects 105 may be made available on smaller hard drives. Also, since the set top boxes 120 do not store entire objects 105 and since download may be controlled by user subscription, authentication and/or other techniques, set top boxes 120 may have limited value on street markets, hopefully deterring set top box 120 theft and hacking and therefore theft of content contained therein.

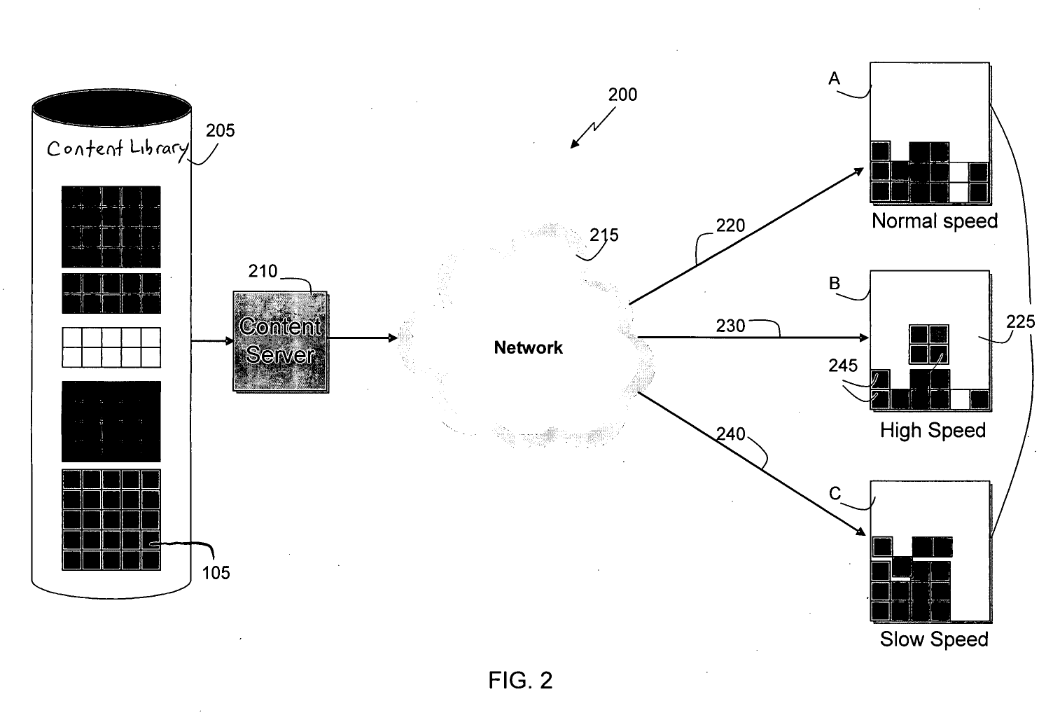

FIG. 2 is a block diagram illustrating an object partitioning and distribution network system 200 implementing dynamic cache updating, in accordance with an embodiment of the present invention. Object partitioning and distribution network system 200 includes a content library 205 coupled to a content server 210. Object partitioning and distribution network system 200 further includes a network 215 (representing a network such as a wide area network, e.g., the internet) coupled between the content server 210 and communication channels 220, 230 and 240, which are in turn coupled to set top boxes 225.

Content library 205 stores multiple (e.g., 100,000) objects 105. Content library 205 may be any conventional database such as a database made by Oracle Corporation of Redwood Shores, Calif. The content library 205 may store the objects 105 in any format (e.g. MPEG-2, MPEG-4, etc.), in any organization, compressed or uncompressed, encrypted or unencrypted, secure or unsecure, etc., so long as the objects can be retrieved preferably quickly. In the movie example, the content library 205 may store hundreds of thousands of movies.

Content server 210 preferably communicates with the content library 205 and the set top boxes 225 to manage object 105 partitioning and distribution. Object partitioning and distribution network system 200 implements a technique termed herein “dynamic cache updating.” Essentially, the dynamic cache updating technique dynamically modifies the size of the lead portion 110 of each object 105 previously stored on a set top box 225, based on such variables as communication capacity, speed and reliability, file size, level of risk, object 105 demand/popularity, etc. for each set top box specifically. As expected, the smaller the lead portion 110 per object 105, the more objects 105 that can be made immediately available. In one embodiment, optimizing the size of the lead portion 110 considers the risk that user consumption of the object 105 will go interrupted. Since many of the variables such as line capacity/speed, reliability, popularity, etc. may change dynamically, the size of the lead portion 110 for each object 105 may also change dynamically. The size of the lead portion 110 will likely be different for the different set top boxes 225. The algorithm for modifying the size of the lead portions 110 due to dynamic cache updating is discussed in greater detail below.

To facilitate description of dynamic cache updating, each of the communication channels 220, 230 and 240 in FIG. 2 are shown to operate at a different broadband capacity and speed. For example, the communication channel 220 provides “normal” broadband capacity and speed (e.g., 1 Mbps), illustrated as “normal speed.” Communication channel 230 provides broadband capacity and speed higher than normal (e.g., 1.5 Mbps), illustrated as “high speed.” And, communication channel 240 provides broadband capacity and speed lower than normal (e.g., 800 Kbps), illustrated as “slow speed.” Because set top box 225A communicates over communication channel 220 at normal speeds, set top box 225A stores an average number of lead portions 110 of objects 105, making an average number of objects 105 available for immediate user consumption. The average number may be several thousand. Because set top box 225B communicates over communication channel 230 at a higher than average speed, set top box 225B stores more than an average number of lead portions 110 of objects 105, making more than an average number of objects 105 available for immediate user consumption. Because set top box 225C communicates over communication channel 240 at a slower than average speed, set top box 225C stores fewer than an average number of lead portions 110 of objects 105, making fewer than an average number of objects 105 available for immediate user consumption. Dynamic cache update also serves the purpose of updating the selection of content on an ongoing basis, e.g., when a new release becomes available, versus just compensating for line conditions.

Each of the set top boxes 120 may come preloaded with a set of objects 105 already stored thereon. The exact list of objects 105 (e.g., title and/or number) need not be the same on each set top box 120. For simplicity of illustration, each of set top boxes 225 in object partitioning and distribution network system 200 comes preloaded with the same set of objects 105 (in this case, optimized for “normal speed” set top boxes 225). Since set top box 225A communicates over normal speeds, set top box 225A illustrates the preloaded set, e.g., six (6) lead portions 110 of objects 105 of 2-3 fragments 245 each (each column representing the lead portion 110 of an object 105). The number of fragments 245 in each lead portion 110 represents the amount of data stored to increase the likelihood that the balance portion 115 of the object 105 will be received without interrupting user consumption. It will be appreciated that an object 105 whose lead portion 110 includes three fragments 245 may be longer or more popular than an object 105 whose lead portion 110 includes two fragments 245.

Upon connection of a set top box 225 to object distribution network system 200, the content server 210 determines line capacity and speed to that set top box 225. Based on this determination, the content server 210 can determine whether the set top box 225 communicates faster or slower than “normal.” If faster, the content server 210 recognizes that fewer fragments 245 per lead portion 110 of object 105 are needed to assure uninterrupted consumption. If slower, the content server 245 recognizes that more fragments 245 per lead portion 110 of object 105 are needed. Updating the set top box 245B that communicates faster than normal, the content server 210 removes fragments 245 from the lead portion 110 of originally loaded objects 105 and adds additional lead portions 110 of objects 105. As illustrated, set top box 245B (which communicates faster than normal) has fewer fragments 245 per lead portion 110 of every object 105 and has two extra lead portions 110 of objects 105 (shown as stacked on top of columns 3 and 4). Similarly, updating the set top box 245C that communicates slower than normal, the content server 210 removes lead portions 110 for one or more objects 105 from the set top box 245 and adds additional fragments 245 to the lead portion 110 of the remaining objects 105. As illustrated, set top box 245C (which communicates slower than normal) has had the lead portions 110 of two objects 105 removed and additional fragments 245 added to the lead portions 110 of the remaining objects 105.

Further, although dynamic cache updating has been described immediately after purchase and initialization, one skilled in the art will recognize that dynamic cache updating can occur throughout the subscription. Dynamic cache updating may be based on line capacity and speed noted over recent performance. Dynamic cache updating may be based on user preferences, object popularity, and other variables affecting object 105 selection and lead portion 110 size. Since communication capacity is inconsistent, the same communication channel may offer better or worse capacity and speed at different times. The content server 210 may test line conditions regularly, and may conduct dynamic cache updating (e.g., every two days) based on a recent history of the line conditions (e.g., the past five (5) days). To have access to more objects 105, dynamic cache updating encourages users to obtain faster communication channels 220, 230 and 240. Further, dynamic cache updating enables the object distribution network system 200 to improve as larger capacity network infrastructures are deployed.

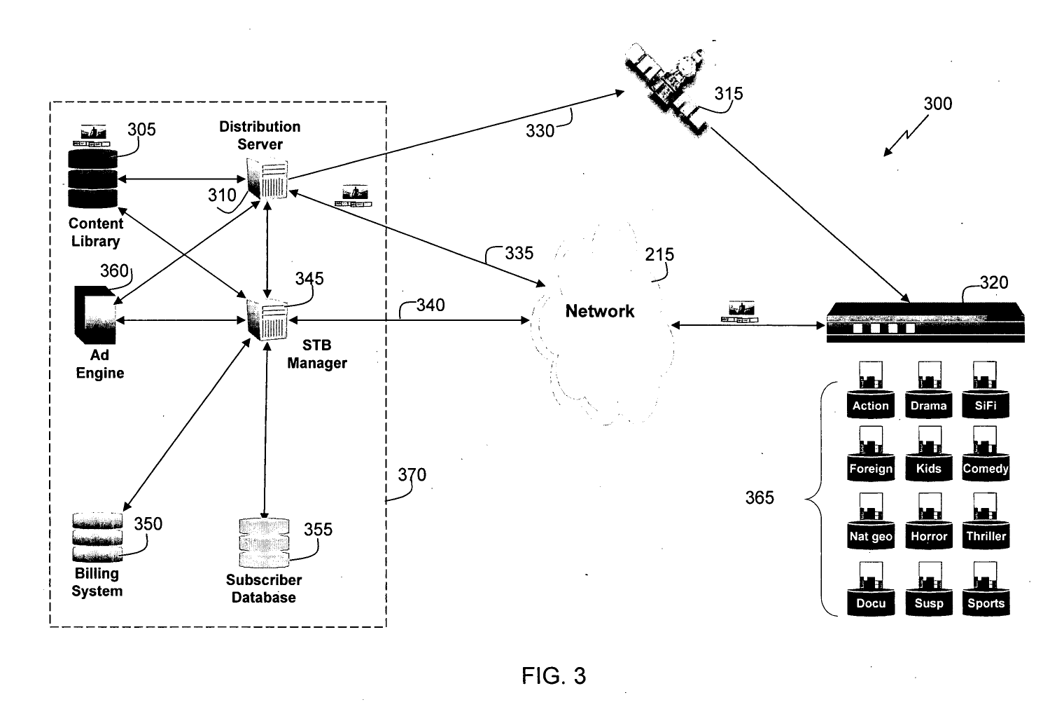

FIG. 3 is a block diagram illustrating an object partitioning and distribution network system 300, in accordance with an embodiment of the present invention. Object partitioning and distribution network system 300 includes set top box (STB) manager 345 coupled to a distribution server 310, to a billing system 350, to a subscriber database 355, to an advertisement (ad) engine 360, to a content library (and engine) 305, and via a communication channel 340 (broadcast or narrowcast) to an network 215, which is coupled to a set top box 320. The distribution server 310 is coupled to the content library 305 and to the ad engine 360. The distribution server 310 is further coupled to a communication channel 330 (broadcast or narrowcast), which is coupled to a satellite 315, which is in turn coupled to the set top box 320. The distribution server 310 is also coupled to a communication channel 335 (broadcast or narrowcast), which is coupled to the network 215 and thus as stated above to the set top box 320. The set top box manager 345, subscriber database 355, billing system 350, distribution server 310, content library 305, and ad engine 360 together make up a content provider 370. One skilled in the art will recognize that content provider 370 can have more, less or different elements. Further, an object partitioning and distribution system 300 may have more than one content provider 370, or more than one of any of its components, e.g., more than one set top box manager 345.

In this embodiment, the set top box manager 345 acts as the central agent attempting to maintain harmonious operation in the network system 300. The set top box manager 345 communicates with the content library 305 to maintain lists of objects 105 available (and possibly maintain lists of related previews and other related objects 105), controls object partitioning and distribution as described with reference to FIG. 1, controls object partitioning and distribution and dynamic cache updating as described with reference to the content server 210 of FIG. 2, controls subscriptions, controls advertisements, controls billing, etc. The set top box manager 345 also maintains content profile information describing the objects 105, categorizes and subcategorizes objects 105, and selects objects 105 for partitioning and distribution based on user preferences and other factors.

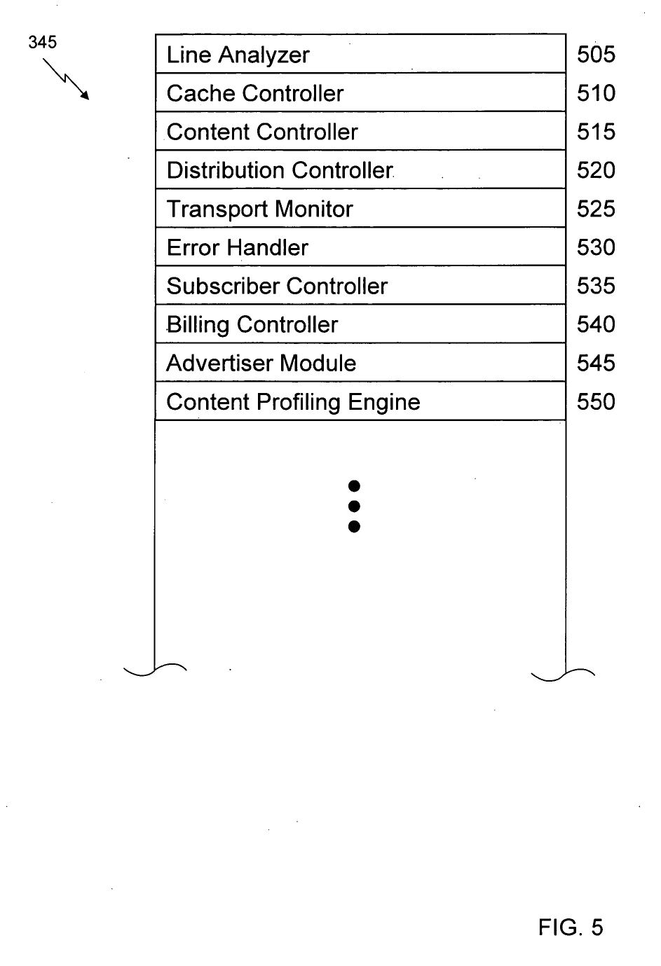

During initialization, the set top box manager 345 communicates over communication channel 340 with the set top box 320 to determine the existence of the set top box 320, to subscribe the user, to profile the hardware, software and content, to determine communication capacity and speed, to start maintaining a historical view of the line condition per set top box 320, to determine user preferences, etc. Based on the information gathered from the user and set top box 320, the set top box manager 345 can establish billing procedures to be effected by the billing system 350, can establish user subscription procedures which it will maintain in subscriber database 355, can instruct the distribution server 310 to effect object partitioning and distribution and dynamic cache updating, and can monitor object streaming to effect error handling if necessary. Further, the set top box manager 345 can monitor viewing habits and user preferences to facilitate targeted advertisements. Additional details of the set top box manager 345 are described with reference to FIG. 5. Alternatively, registration can take place over the Internet through a web interface or over the phone with an operator who can relay the collected data to set top box manager 345.

Based on instructions received from the set top box manager 345, whether during initialization or general operation, the distribution server 310 sends lead portions 110 of objects 105 possibly using broadcast communications to set top box 320, although narrowcast communications are also possible. Since dynamic cache updating and streaming of the balance portion 105 are user and time specific, the distribution server 310 preferably uses narrowcast communications to effect dynamic cache updating and data streaming of the balance portion 115 of object 105 to the set top box 320. If communication channel 335 fails or slows down, the distribution server 310 can effect dynamic cache updating and data streaming by other communication channels, e.g., communication channel 330 (via broadcast or narrowcast transmissions, e.g., using the unused bandwidth of satellite transmissions).

The distribution server 310 communicates with content library and engine 305 to gather lead portions 110 for distribution and balance portions 115 for streaming. Per instructions from the set top box manager 345, the distribution server 310 communicates with ad engine 360 to gather advertisements to be sent to the set top box 320, whether the advertisements are included in the lead portions 110, in the balance portions 115, in dedicated transmissions, or in other transmissions.

During general operation, the set top box 320 enables a user to watch previews or advertisements previously loaded in their entirety onto the set top box 320, to select objects 105 for consumption, to consume a selected object 105 initiating with the lead portion 110 previously loaded, to receive and store the balance portion 115 of the selected object 105 for continuous consumption without interruption, and to set user preferences (including preferred object types, parental content control, specific object selections, etc.). Other functionality may be included on set top box 320 such as digital video recorder (DVR) functionality, the prior art alternative to true video on demand services (e.g., downloading entire objects with a wait), television control, DVR (e.g., TiVo-type) control, etc.

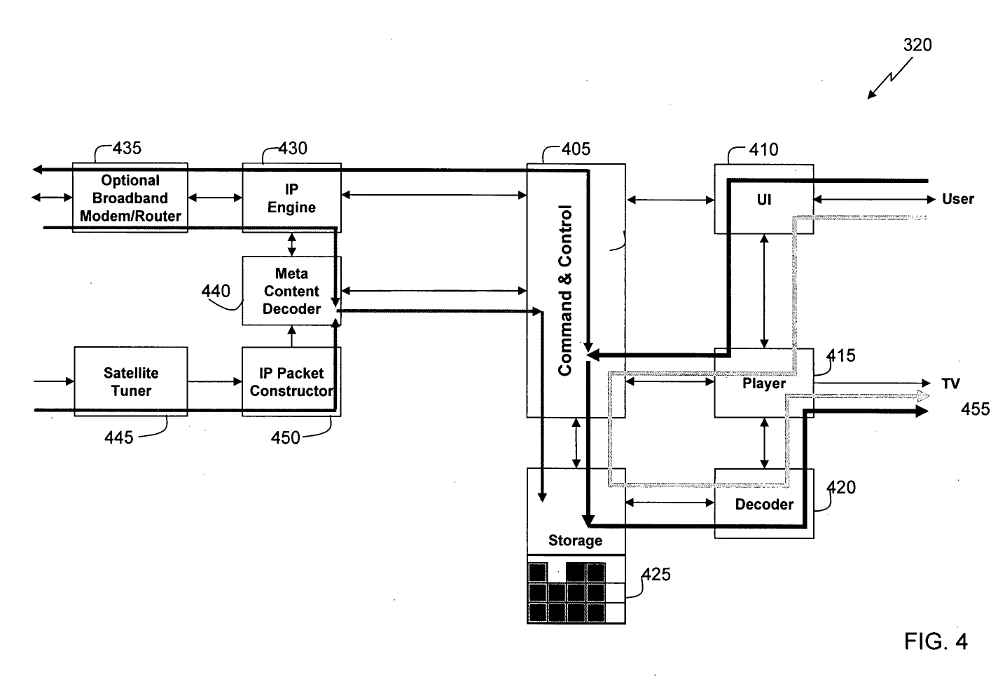

The set top box 320 may organize object 105 titles (or other indicia) in categories, so that a user can locate them easily. An example user interface 365 for movie objects 105 is shown in FIG. 3 underneath set top box 320. As shown, each of the movies are categorized into movie genres like action, drama, SciFi, foreign, kids, comedy, etc. A user can select a movie by browsing the movie categories, by searching for the movie by title, actor, etc. Additional details of the set top box 320 are described below with reference to FIG. 4. Set top box 320 may also provide previews of upcoming releases scheduled for delivery at public theaters. The set top box 345 may provide a link to ticketing entities like Fandango enabling a user to reserve and/or purchase tickets to movies in public theaters. The set top box 320 may also provide previews of releases which will become available on the set top box 320 in the future.

The billing system 350 receives instructions from the set top box manager 345 to bill a user based on subscription charges, use charges, etc. The method of payment may be based on billing preferences set by the user, e.g., invoices, automatic charges to credit cards, automatic withdrawal from bank accounts or prepayment accounts, etc. Billing can be based on rental period, time of use, number of copies made, prepaid programs, subscriptions, etc. Billing system 350 may also receive instructions from the set top box manager 345 to bill an advertiser on per ad charges, on length of advertisements, or on other factors.

The subscriber database 355 stores subscriber information, including contact information, set top box 320 information (hardware configurations, software configurations, etc.), user information, preference information, communication capacity and speed information, content information (including object identification information, lead portion 110 start and finish addresses, etc.), billing preferences, statistics information, account status information, etc.

The ad engine 360 stores advertisements. These advertisements may be associated with conditions for deployment. The set top box manager 345 may indicate the current conditions, e.g., user demographics, viewing habits, preferences, etc., to the ad engine 360, which will select an advertisement and forward it to the distribution server 310 accordingly. Alternatively, the set top box manager 345 may select the advertisement based on the conditions, and instruct the ad engine to deploy the selected ads.

FIG. 4 is a block diagram illustrating details of the set top box 320, in accordance with an embodiment of the present invention. Set top box 320 includes a command & control module 405 coupled to a user interface 310, to a player 415, to a storage device 425, to an IP engine 430, and to a meta content decoder 440. IP engine is further coupled to broadband modem/router 435 and to the meta content decoder 440. The meta content decoder 440 is coupled to an IP packet constructor 450, which in turn is coupled to a satellite tuner 445. The player 415 is coupled to the user interface 410, to a television 455 and to a decoder 420, which in turn is coupled to the storage device 425. Although the label “IP engine” suggests use of the Internet Protocol, one skilled in the art will recognize that the IP engine 430 can be any communication engine that uses any format and/or protocol. The set top box 320 may be incorporated into the consumption device 455, can be part of a computer (which acts as or is separate from the consumption device 455), etc.

The command & control module 405 is the central agent that attempts to maintain smooth operation of the set top box 320. Via the user interface 410, which may be a graphical user interface, the command & control module 405 receives requests from the user. These requests may include requests for lists of available titles, requests to view previews, requests to consume an entire object 105, requests to modify user preferences, consumption control (e.g., play, pause, rewind), requests to change user billing preferences, add/delete services, impose spending limits, etc. Command & control module 405 effects procedures to respond to the user requests.

In response to a user request to view a list of titles of available objects 105, the command & control module 405 forwards a content list to the user interface 410. The user interface 410 may present the content list to the user by video, audio, or other mechanism. The list may be stored within the command & control module 405 or stored in and retrieved from the storage device 425. The content list may be organized alphabetically, categorically, or using other organization. The content list is preferably generated by the set top box manager 345, and sent with each dynamic cache update to the set top box 320 for storage. The user makes selections from the content list. A selection may include a request to view a preview for an object 105 currently available in the set top box 320, to view a preview for an object 105 currently unavailable in the set top box 320, to view an object 105 currently available in the set top box 320, or to view an object 105 currently unavailable in the set top box 320.

In response to a user request to consume a preview for an object 105 whose lead portion 110 is currently available on the set top box 320, the command & control module 405 instructs the storage device 425 to stream the previously loaded/stored preview to the decoder 420, which decodes (e.g., using MPEG-4, MPEG-2 or the like, if necessary) and streams the preview to the player 415, which in turn streams the preview to the consumption device 455, e.g., TV 455. It will be appreciated that the consumption device 455 may alternatively or additionally include user interface 410. Further, the user interface 410 and consumption device 455 may include the overlapping components or be the same device.

In response to a user request to consume an object 105 currently available on the set top box 320, the command & control module 405 communicates via the IP engine 430 and broadband modem/router 435 with the set top box manager 345 to determine current communication channel conditions. Based on current line capacity and speed, the set top box manager 345 may determine that current line conditions are within expected limits, better than expected or worse than expected. If as expected or better than expected, then the set top box 320 can operate under normal conditions. The set top box manager 345 may instruct the command & control module 405 to initiate consumption immediately or to play one or more previews previously loaded (for a more realistic cinematic experience). If previews are played, then this could give the set top box manager 345 a head-start on downloading the balance portion 115 of the requested object 105.

If line conditions are worse than expected, then the set top box manager 345 may instruct the command & control module 405 to respond in one of several ways. The set top box manager 345 may instruct the command & control module 405 to play several previews (or shorts, e.g., cartoons, previously loaded onto the set top box 320) based on the amount of time needed to download the additional lead portion 110 of the requested object 105 to assure uninterrupted consumption. The set top box manager 345 may instruct the command & control module 405 to inform the user of the condition via the user interface 410 or consumption device, e.g., TV 455. The set top box manager 345 may instruct the set top box 320 to operate as if no problems existed, and may assign additional communication channels to handle the deficit.

After the set top box manager 345 and set top box 320 manage current line conditions, the command & control module 405 instructs the storage device 425 to stream the lead portion 110 of the requested data object 105 to the decoder 420, which decodes and streams the lead portion 110 to the player 415, which in turn streams the lead portion 110 to the consumption device 455. (The term “forward” should be interpreted to include streaming. The term “stream” should be interpreted to include forwarding data as it arrives, rather than waiting to forward the data only after an entire data set has arrived. However, if an embodiment identifies streaming, one skilled in the art will recognize that any type of forwarding can alternatively be used.) While the lead portion 110 is being consumed, the command & control module 405 instructs the IP engine 430 to request the balance portion 115 of the object 105 from the set top box manager 345. The IP engine 430 obtains and transmits the requisite information, e.g., the request, object 105 identifying information, user authentication information, etc. to the broadband modem/router 435, which forwards the requisite information to the set top box manager 345. Assuming proper authentication and privileges, the balance portion 115 of the object 105 is streamed from the distribution server 310 to the broadband modem/router 435 and/or to the satellite tuner 445. Upon receiving the stream by the broadband modem router 435, the IP engine 430 streams the incoming balance portion 115 to the command & control module 405, which streams the incoming balance portion 115 to storage device 425 for consumption in due course. Similarly, upon receiving the stream by the satellite tuner 445, the IP packet constructor 450 streams the incoming balance portion 115 to the command & control module 405, which streams the incoming balance portion 115 to storage device 425 for consumption in due course. As stated above, the IP engine 440 and/or IP packet constructor 450 may forward the incoming balance portion 115 stream via the meta content decoder 440 to the command & control module 405. The set top box manager 345 and/or distribution server 310 may select the communication channel, e.g., narrowcast through satellite or cable or both combined, based on transmission speeds, network stability, risk management, object 105 popularity, etc.

In response to a user request to consume a preview or an object 105 currently unavailable on the set top box 320, the command & control module 405 instructs the IP engine 430 to request the preview or object 105 from the set top box manager 345. The IP engine 430 obtains and transmits the requisite information, e.g., the request, preview or object identifying information, user authentication information, etc., to the broadband modem/router 435, which forwards the requisite information to the set top box manager 345. Assuming proper authentication, the preview or object 105 currently unavailable may be forwarded or streamed from the distribution server 310 to the broadband modem/router 435 and/or to the satellite tuner 445. Upon receipt by the broadband modem router 435, the IP engine 430 forwards or streams the preview or object 105 to the command & control module 405, which forwards or streams the preview or object 105 to storage device 425 for immediate or future consumption. Similarly, upon receipt by the satellite tuner 445, the IP packet constructor 450 forwards or streams the preview or object 105 to the command & control module 405, which forwards or streams it to storage device 425 for immediate or future consumption.

IP engine 440 and/or IP packet constructor 450 may forward or stream the incoming preview or object 105 via the meta content decoder 440 to the command & control module 405. Meta content decoder 440 assists with decoding the content, in this case. Meta content decoder 440 may indicate missing packets, may manage duplicate packets from one or more communication channels, may decompress files, etc. An example of meta content decoder 440 is described in U.S. Pat. No. 6,614,366 to Digital Fountain of Fremont, Calif., which is hereby incorporated by reference as if repeated verbatim hereafter.

It will be appreciated that the incoming object 105 may be a preview, partitioned with a lead portion 110 and balance portion 115, so that the preview can begin playback upon receipt of the lead portion 110. Alternatively, if the incoming content is a preview, the set top box manager 345 and set top box 320 may treat it differently, by waiting for the entire preview to be loaded. Then, while the preview is being consumed, the set top box manager 345 may initiate downloading the lead portion 110 of the object 105 to get a jump-start.

For security purposes, during or after consumption of object 105, command & control module 405 may instruct the storage device 425 to erase segments, e.g., random minutes, of the balance portion 115 (or other portions). That way, after the entire object 105 has been consumed by the user, the entire object 105 is not stored on the set top box 320. Not storing the entire object 105 may deter theft and hacking. Further, objects 105 may persist on the set top box 345 for varying lengths of time, possibly depending on the terms of purchase (e.g. 24 hr/week rental, or outright purchase).

FIG. 5 is a block diagram illustrating details of the set top box manager 345, in accordance with an embodiment of the present invention. Set top box manager 345 includes a line analyzer 505, cache controller 510, content controller 515, distribution controller 520, transport monitor 525, error handler 530, subscriber controller 535, billing controller 540, advertiser module 545 and content profiling engine 550.

The line analyzer 505 communicates with the set top boxes 120, 225, 320 to determine communication capacity and speed. Line analyzer 505 may select from any conventional algorithm for computing capacity and speed of a broadband connection. Line analyzer 505 continues to monitor communication capacity and speed throughout the subscription for dynamic cache updating and/or transport monitoring.

Cache controller 510 obtains communication capacity and speed information regarding each of the set top boxes 345. Applying algorithms that take into account communication capacity and speed, inconsistencies, risk management, hard drive size, object 105 popularity, and/or the like, cache controller 510 determines on a per object 105 basis how large the lead portion 110 should be. The cache controller 510 may also take into account consumption of previews prior to initiation of the lead portion 110. Since previews are typically stored on the set top box 320 itself, consuming previews prior to initiating consumption of the lead portion 110 can give the network system 300 a head-start on downloading the balance portion 115 of the requested object 105.

An example equation for determining cache size as a function of line condition is as follows:
X=P−(W−B)*S*(1−D)
Cache (%)=X/P
where
X=Cache size
P=Total object size
W=Object watch time
B=Time buffer (or final bit lead time)
S=Listed or Average Broadband speed
D=% Degradation allowed
Cache=The size of lead portion 110 as a percent of the size of object 105

Example
P=1 Gigabyte (8,589,934,592 bits)
W=2 hours (7200 seconds)
B=5 minutes (300 seconds)
S=1 Mbps (1,048,576 bps)
D=10%
Thus, X=8,589,934,592−(7200−300)*1,048,576(1−0.1)=2,078,277,632 bits
Cache (%)=2,078,277,632/8,589,934,592=24.19%

A table showing the number of lead portions 110 that can be stored on hard disks of various sizes is shown below. The size of each lead portion 110 is based on communication channel conditions assuming two hour movies of 1 GB file size as objects 105, etc. The algorithm for determining cache (% of movie) is shown immediately above.

| Pre-Cached VOD | | | | |
|---|---|---|---|---|
| Listed Broadband Bandwidth | 1.00 | 1.25 | 1.50 | 1.75 |
| BW (Mbps) | | | | |
| Average Broadband Degradation | 10% | 15% | 20% | 25% |
| (%) | | | | |
| Adjusted Broadband BW (Mbps) | 0.9000 | 1.0625 | 1.2000 | 1.3125 |
| Final Bit Lead Time (min) | 5 | 5 | 15 | 20 |
| Cache (% of Movie) | 24.19% | 10.51% | 7.71% | 3.87% |
| Movie Size (GB) | 1.0 | 1.0 | 1.0 | 1.0 |
| Movie Length (min) | 120 | 120 | 120 | 120 |
| Movie Download Time (min) | 151.70 | 128.50 | 113.78 | 104.03 |
| Cache (Lead Portion) (GB) | 0.2419 | 0.11 | 0.08 | 0.04 |
| Cache (Lead Portion) Length | 29.03 | 12.61 | 9.26 | 4.64 |
| (min) | | | | |
| Cache Download Time (min) | 36.70 | 13.50 | 8.78 | 4.03 |
| Balance Portion (GB) | 0.7581 | 0.89 | 0.92 | 0.96 |
| Balance Portion Length (min) | 90.97 | 107.39 | 110.74 | 115.36 |
| Balance Portion Download Time | 115.00 | 115.00 | 105.00 | 100.00 |
| (min) | | | | |
| Achieved Final Bit Lead Time | 5.00 | 5.00 | 15.00 | 20.00 |
| Allowed Average Broadband | 0.8625 | 1.0182 | 1.0500 | 1.0938 |
| BW (Mbps) | | | | |
| Allowed Average Degradation | 13.75% | 18.54% | 30.00% | 37.50% |
| (%) | | | | |
| Capacity | | | | |
| Disk-300 (GB) | 1,178 | 2,712 | 3,694 | 7,365 |
| Disk-400 (GB) | 1,571 | 3,617 | 4,926 | 9,820 |
| Disk-500 (GB) | 1,963 | 4,521 | 6,157 | 12,275 |

After a user has selected an object 105 but before consumption begins, the line analyzer 505 and transport monitor 525 may analyze communication channel conditions to determine whether conditions are within expected tolerances. If not, then the system 300 may respond in a manner to reduce the risk of interrupted consumption. An example analysis for determining a number of previews to play to reduce the risk of interruption is provided below. For this example, it is assumed that line conditions are 5% below capacity/speed last determined by the line analyzer 505.

Pre-play Broadband Degradation Compensation

| | | | | |
|---|---|---|---|---|
| Pre-play Degrada- | 5% | 5% | 5% | 5% |
| tion (%) | | | | |
| Pre-play Bandwidth | 0.8500 | 1.0000 | 1.1250 | 1.2250 |
| (Mbps) | | | | |
| Time to Download | 121.76 | 122.19 | 112.00 | 107.14 |
| Balance (min) | | | | |
| Additional Delay | 6.76 | 7.19 | 7.00 | 7.14 |
| (min) | | | | |
| Unmanageable Delay | 6.76 | 7.19 | — | — |
| (min) | | | | |
| # Previews for | 4.00 | 4.00 | — | — |
| Unmanageable Delay | | | | |
| Allowed Average | 0.8165 | 0.9607 | 0.9921 | 1.0323 |
| Broadband BW (Mbps) | | | | |
| Allowed Average | 18.35% | 23.14% | 33.86% | 41.01% |
| Degradation (%) | | | | |

Since the communication capacity/speed is 5% below the capacity/speed last determined, the time to download the balance portion 115 of the object 105 for the 1 Mbps channel is now 121.76 minutes. This represents 1.76 minutes over the two hour consumption time. To receive the last bit five minutes before the end of the movie, the system 300 must postpone playback 6.76 minutes. At two minutes per preview, four previews must be consumed to resume safe conditions. If the system can handle the additional delay, e.g., see the third and fourth columns above for 1.5 Mbps and for 1.75 Mbps respectively, then nothing need change.

Further, to simulate a true instantaneous VOD experience for an object 105 currently unavailable on the set top box 320, the system 300 may initiate consumption of a number of previews (or shorts). The number of previews indicated in the table below represent the time needed to download the entire lead portion 110 based on the capacity/speed of the channel. For example, the lead portion 110 of a 1 GB movie for a 1 Mbps channel is 36.7 minutes (see first table above). This represents nineteen previews. For a 1.75 Mbps channel requiring 4.03 minutes to download the lead portion 110 needed, only three previews need be played to reduce the risk of interrupted consumption.

Time-Shifted Video On Demand (VOD)

| | | | | |
|---|---|---|---|---|
| Number of Previews (each 2 min) | 19 | 7 | 5 | 3 |
| Needed to Deliver Time-Shifted VOD | | | | |
| (Unavailable Movie) | | | | |

As stated above, one possible variable of risk management may include popularity of content. Higher demand content, such as new releases, may deserve additional resiliency and protection. That is, if the system could foresee which objects 105 a user is going to select, then the system could afford additional resiliency and protection to those objects 105. Object popularity suggests likelihood of demand and statistically justifies added protection. Further, if an object 105 is requested by a large number of users, greater loss of profit (e.g., refunds) could result from system error. If an object 105 is selected by few users, then system error may not be as great a concern to the service provider. Additional resiliency and protection could come in the form of larger lead portion 110 size than deemed necessary under normal circumstances. An example equation accounting for popularity follows:
Y=F/M+(F*R/$100 m)/M+F*A*t+F*(a*a′, b*b′, c*c′, . . . )
X′=X*(1+Y)
where
X′ New cache size
X Initial cache size deemed necessary
Y Additional percentage to be added to initial cache size
F Constant (to be adjusted as field data becomes available, initial value=5%)
M Number of months since released
R Box office Revenue generated
A Number of awards
t aging factor
a, b, c, . . . represent other characteristics which will be taken into consideration in the future
a′, b′, c′, . . . represent aging factors

Example for Movie1 Two Months after Release (Assume $200 m):
Y=5%/2+(5%*$200 m/$100 m)/2+5%*0=7.5%
X′=X*(1+7.5%)

Example for Movie1 Three Months Later (Assume $200 m):
Y=5%/5+(5%*$200 m/$100 m)/5+5%*0=3%
X′=X*(1+3%)

Cache controller 510 preferably stores pointers indicating the size of each lead portion 110 for each object 105, so that balance portions 115 can be determined and dynamic cache updating can be effected without first communicating with the set top box 320.

Content controller 515 applies user preferences and user history to select which objects 105 from the content library 305 to make available. For example, content library 205, 305 may store 100,000 objects 105. However, set top box 225, 320 may only be able to store 10,000 lead portions 110 of objects 105. Content controller 515 determines which 10,000 lead portions 110 to provide to set top box 225, 320. In the movie example, if the user indicates a high preference for action films and a low preference for children films, the content controller 515 may make significantly more action films available. The content controller 515 may select from the action films arbitrarily, based on past object 105 selections, based on titles, based on popularity, based on peer selections, etc. Content controller 515 preferably stores information identifying the lead portions 110 currently loaded on each set top box 320. That way, content control can be effected without first communicating with the set top box 320.

Content controller 515 may associate previews with objects 105, so that preselected previews can be consumed prior to consumption of the object 105 (in the movie embodiment). Alternatively, associations between objects 105 and previews may be managed by managers of content library 305. Upon user selection of an object 105, the content controller 515 may select previews based on these associations for initial playback. Further, user selection of an object 105 may cause the content controller 515 to select objects 105 associated with the selected object 105 to be made available on the set top box 320. It will be appreciated that content controller 515 and cache controller 510 effect the content selection and lead portion 115 size aspects, respectively, of dynamic cache updating.

Distribution controller 520 instructs the distribution server 310 to send previews, lead portions 110, balance portions 115, and advertisements (not shown) to set top box or set top boxes 120, 225, 320. Generally, distribution controller 520 instructs the distribution server 310 to send previews (not shown) via broadcast channels to all set top boxes 320 or via narrowcast channels only to set top boxes 320 having user preferences warranting such previews. In one embodiment, distribution controller 520 instructs the distribution server 310 to send lead portions 110 via broadcast channels to those set top boxes 320 having user preferences warranting such receipt. Generally, the distribution controller 520 instructs distribution server 310 to send previews and lead portions 110 through communication channels 330 and/or through communication channels 335. In one embodiment, distribution controller 520 instructs distribution server 310 to send dynamic cache updating information via communication channels 335 to all corresponding set top boxes 320, and to stream the balance portions 115 of objects 105 to all requesting set top boxes 320. The distribution server 310 could send dynamic cache updating information and balance portions 115 via narrowcast or broadcast channels.

The transport monitor 525 monitors communication capacity during consumption of the balance portion 115 of an object 105. The transport monitor 525 may cooperate with the line analyzer 505, or may include line analyzer components therein. Based on communication capacity and speed during object 105 consumption, the transport monitor 525 may determine that engaging additional communication channels (e.g., broadcast channels 330) may be necessary to reduce risk of interruption, may determine that a fatal error has occurred, may determine that communication capacity and speed are greatly ahead of schedule, or may determine that everything is going fine.

Error handler 530 communicates with the transport monitor 525 to determine if a response is necessary. For example, if before initiating consumption of the requested object 105 the transport monitor 525 determines that line conditions are below expectation, the error handler 530 may instruct the set top box 320 to initiate consumption of a few previews (or shorts) before initiating consumption of the lead portion 110. Additionally or alternatively, the error handler 530 may instruct the set top box 320 to postpone initiating consumption and instruct the cache controller 510 to dynamically update the lead portion 110 of the object 105 on the set top box 320. If the transport monitor 525 determines that line conditions have degraded such that a fatal error has occurred, then the error handler 530 may communicate directly with the set top box 320 via communication channel 340 to inform it of the fatal error (possibly giving the user the option to wait for the download or cancel the request). Alternatively or additionally, if before or during consumption the transport monitor 525 determines that communication capacity and speed have degraded below expectation, then the error handler 520 could assign additional communication channels to the exchange. That is, the error handler 530 could instruct the distribution controller 520 to instruct the distribution server 310 to send data across channels 330 in addition to the data being sent across the channels 335 via network. Still further, the error handler 530 could instruct the billing controller 540 to refund any charges, give the user a free download, etc.

The subscriber controller 535 communicates with the set top box 320 via communication channel 340 to obtain user information, hardware and software profile information, user preferences including preferred billing modes, preferred object types (e.g., movie genres, music preferences, etc.), user habits, statistics, etc. The subscriber controller 535 stores this information to quickly determine authentication, user privileges (e.g., adult content), subscription information (such as cost per download, monthly service charges, etc.), targeted advertisements, etc.

The billing controller 540 communicates with the billing system 350, which effects charges. As stated above, the billing controller 540 instructs the billing system 350 to bill a user based on subscription charges, use charges, rental period, time of use, number of copies made, prepaid programs, other product purchases such as a DVD, other product or services as advertised by the ad engine 360, etc. The method of payment may be based on billing preferences set by the user, e.g., invoices, automatic charges to credit cards, automatic withdrawal from bank accounts or prepayment accounts, etc. The billing controller 540 also instructs the billing system 350 to effect refunds and credits. Further, the billing controller 540 may instruct the billing system 350 to bill advertisers based on per ad charges, length of advertisements, or other variables.

The advertiser module 545 may provide the ad engine 360 advertisement selection information which the ad engine 360 uses to select targeted advertisements and/or advertisement campaigns. The ad engine 360 then can forward the selected advertisements to the distribution server 310 for deployment. Alternatively, the advertiser module 545 may use the advertisement selection information to select particular advertisements for deployment by the ad engine 360. For improved targeting, the ad engine 360 may store several versions of an advertisement, e.g., one in English, one in Spanish, one action based, one comedy based, etc. The advertisement selection information may include user preferences, past behaviors and current requests to the ad engine 360. For example, if the user prefers Spanish, the ad engine 360 or advertiser module 545 may select the Spanish version of an advertisement. Further, if the user regularly watches movies in Spanish, the ad engine 360 or advertiser module 545 may select the Spanish version of an advertisement. If a user tends to prefer action movies, an action-based advertisement may be selected. Also, if the user has currently selected a comedy to watch, a more humorous advertisement may be selected. These and other variables may be examined to select advertisements. Further, based on user subscription, user preferences, user habits, or other factors, the advertiser module 545 and/or ad engine 360 may decide not to send an advertisement with the content selected.

Content profiling engine 550 gathers information about objects 105 for the content controller 515 and cache controller 510. For a movie embodiment, this information may include box-office sales, review information, date of first release, categorizing and subcategorizing information, object popularity, object awards, etc. Based on this profiling, the content controller 515 can determine whether to include an object 105 in a users list of objects 105 available for immediate viewing. Based on this profiling, the cache controller 515 can determine levels of risk, which may affect lead portion 110 size.

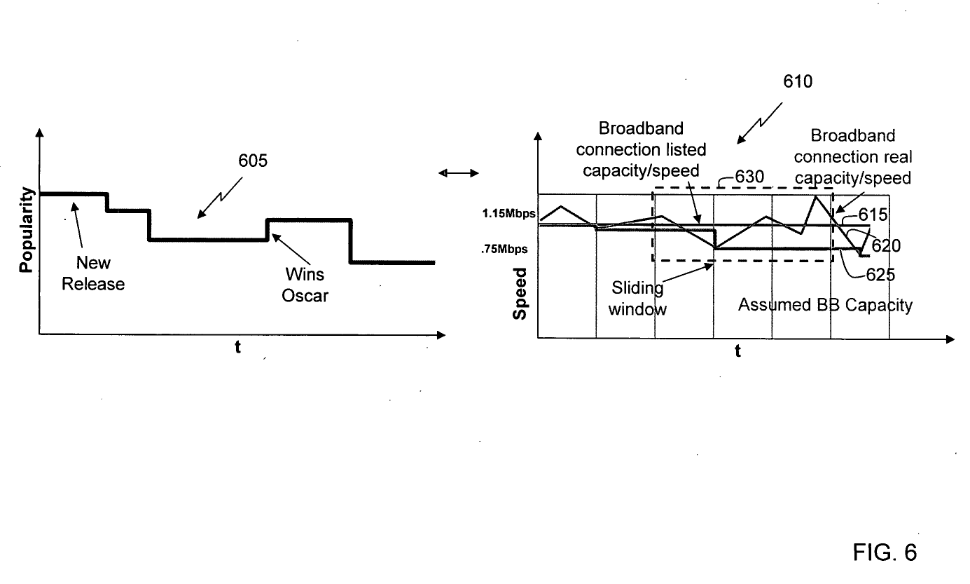

FIG. 6 is a graphical representation of example factors for determining lead portion 110 size, in accordance with an embodiment of the present invention. Graph 605 shows the popularity of a movie as a function of time. As shown, this movie is generally becoming less popular over time (e.g., days). However, it's popularity increased when it won an Oscar. Other events (such as the release of a sequel) could also cause changes in popularity. As stated above, popularity can affect demand and thus cache size.

Graph 610 shows line conditions over the same period of time as graph 605. Line 615 represents a particular broadband connection's listed capacity/speed. As shown, the listed speed of this connection is 1.15 Mbps. Line 620 represents the actual capacity/speed of the particular broadband connection. As shown, the actual capacity/speed fluctuates over time, sometimes operating faster than listed and sometimes operating slower than listed. Window 630 represents the data used to compute line conditions for this particular broadband connection. At analysis time (t_{A}), the line analyzer 505 will look to data within window 630 to determine the assumed capacity/speed of the broadband connection. This window 630 may represent the last fifteen days. The line analyzer 505 may compute the capacity speed regularly (e.g., monthly, weekly, daily, hourly, continuously, etc.). Line 625 represents the capacity/speed computed by the line analyzer 505 and used by the cache controller 510. As shown, line 625 follows the worst case condition within the window 630 (preferably subtracting a small percentage for possible variations). For the window 630, the worst case condition is about 0.75 Mbps. Accordingly, line analyzer 505 may compute a capacity/speed 5% less than 0.75 Mbps, i.e., around 0.7125 Mbps. It will be appreciated that, should a broadband connection fail completely, the line analyzer 505 may retry after some predetermined time period (e.g., one hour), may select an arbitrary minimum (e.g., 20% less than the listed capacity/speed, or a predetermined minimum such as 8 Mbps), may contact someone to check on the connections, etc.

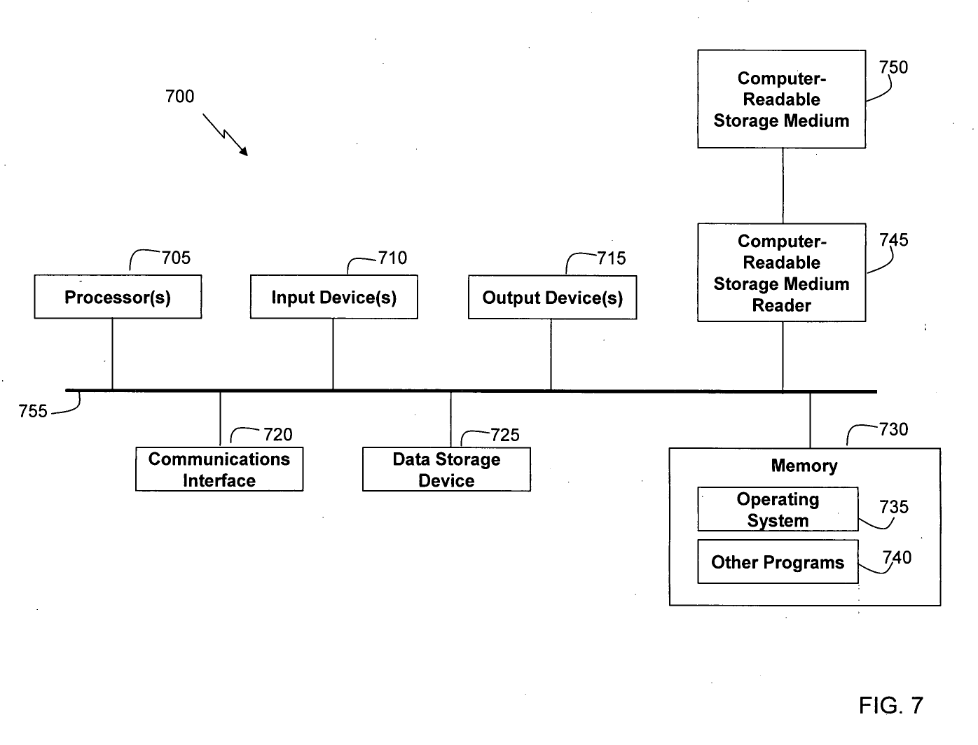

Each of content library 305, distribution server 310, set top box 320, set top box manager 345, ad engine 360, billing system 350, subscriber database 355 may be disposed on one or more computer systems. FIG. 7 is a block diagram illustrating details of an example computer system 700. Computer system 700 includes a processor 705, such as an Intel Pentium® microprocessor or a Motorola Power PC® microprocessor, coupled to a communications channel 755. The computer system 700 further includes an input device 710 such as a keyboard or mouse, an output device 715 such as a cathode ray tube display, a communications device 720, a data storage device 725 such as a magnetic disk, and memory 730 such as Random-Access Memory (RAM), each coupled to the communications channel 755. The communications interface 720 may be coupled to a network such as the wide-area network commonly referred to as the Internet. One skilled in the art will recognize that, although the data storage device 725 and memory 730 are illustrated as different units, the data storage device 725 and memory 730 can be parts of the same unit, distributed units, virtual memory, etc.

The data storage device 725 and/or memory 730 may store an operating system 735 such as the Microsoft Windows NT or Windows/95 Operating System (OS), the IBM OS/2 operating system, the MAC OS, or UNIX operating system and/or other programs 740. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 700 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 745 such as a magnetic disk drive, hard disk drive, magneto-optical reader, CPU, etc. may be coupled to the communications bus 755 for reading a computer-readable storage medium (CRSM) 750 such as a magnetic disk, a hard disk, a magneto-optical disk, RAM, etc. Accordingly, the computer system 700 may receive programs and/or data via the CRSM reader 745. Further, it will be appreciated that the term “memory” herein is intended to cover all data storage media whether permanent or temporary.

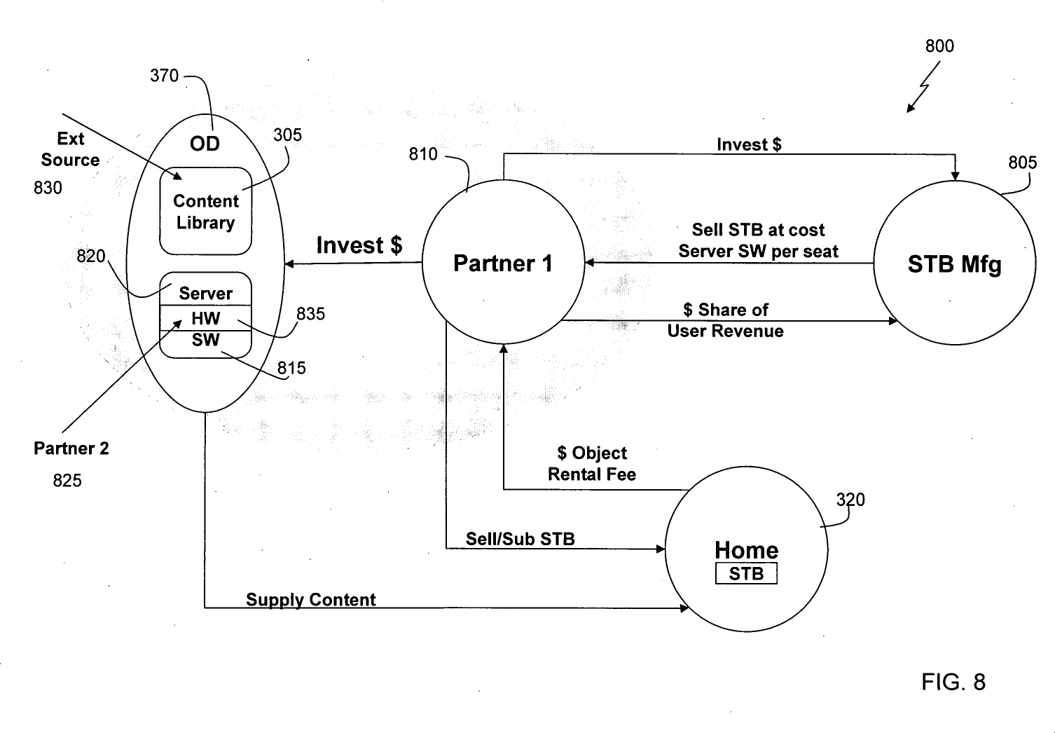

FIG. 8 is a block diagram of a business model 800 for implementing an object partitioning and distribution system 300, in accordance with an embodiment of the present invention. The business model 800 includes a set top box manufacturer 805, a first partner 810, a second partner 825 and an external source 830.

The first partner 810 (e.g., a telephone provider, Blockbuster Inc., satellite provider, cable provider, the like, or a combination) invests in the set top box manufacturer 805. The set top box manufacturer 805 builds set top boxes 320 including all content provider 370 software 815, which the set top box manufacturer 805 sells to the first partner 810.

The first partner 810 also invests in the development of the content provider 370 (labeled OD for “on-demand”). In the example shown, content provider 370 includes a content library 305 and a server 820 (including hardware HW 835 and software SW 815). An external source 810 (e.g., Blockbuster Inc. or other source) populates the content library 830. The hardware 835 may be provided by the second partner 825 or purchased by the first partner 810.

The first partner 810 sells, rents or gives the set top boxes 320 to customers. The customers possibly pay a rental or subscription fee for the set top box 320 and/or service. Upon selection of an object 105 for consumption, the customer pays an object rental fee to the first partner 810. A share of the user revenue (whether from rental and/or subscription fees) to the set top box manufacturer 805. The content provider 370 supplies the objects 105 to the set top box 320. For the hardware, the second partner 825 and/or external source 830 may get paid or get a share of user revenue.

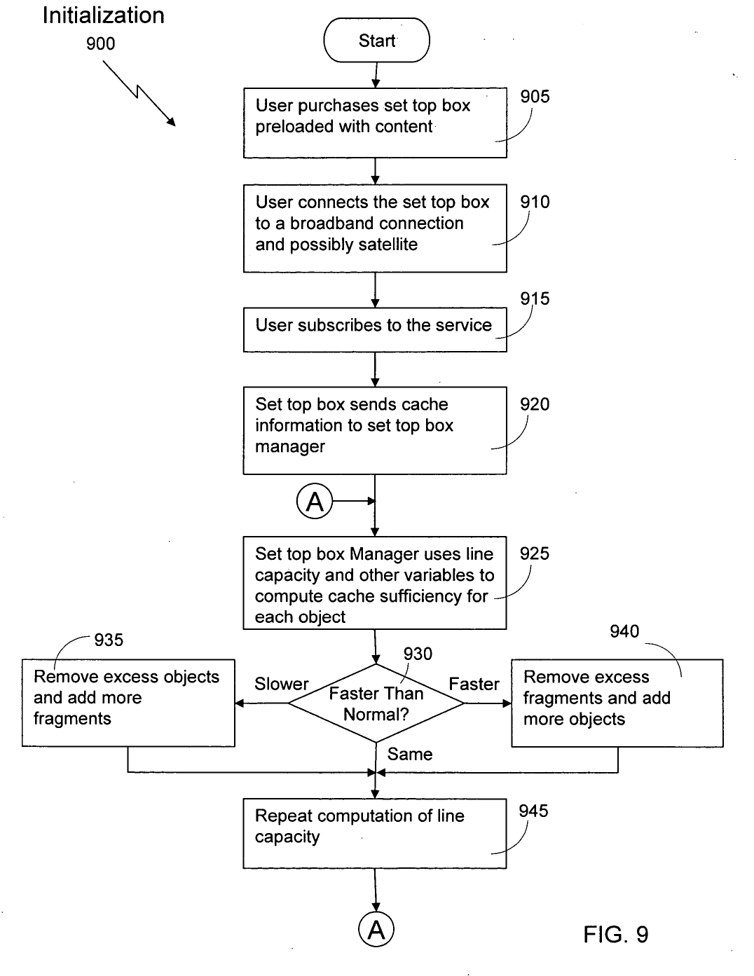

FIG. 9 is a flowchart illustrating a method 900 of initializing a set top box 320 into an object partitioning and distribution system 300, in accordance with an embodiment of the present invention. Method 900 begins with the user in step 905 buying a set top box 320 preloaded with content, i.e., lead portions 110 of objects 105. The user in step 910 connects the set top box 320 to a broadband connection (e.g., internet broadband via cable or DSL) and possibly to satellite (or other television connection). The user in step 915 subscribes to the virtual video on demand service, possibly via the set top box 320, web interface or phone call to customer service. The set top box 320 in step 920 sends profile information (e.g., cache information, address information, version information, etc.) to the set top box manager 345. The set top box manager 345 in step 925 updates the lead portions 110 and/or previews on the set top box 320, and uses line capacity, line speed and other variables to compute cache sufficiency, e.g., to determine optimum lead portion 110 size for each object 105. If the set top box manager 345 in step 930 determines that line conditions or other factors (e.g., line capacity, speed, risk management) merit protection for worse than normal conditions, then the set top box manager 345 in step 935 instructs the set top box 320 to remove excess objects 105 and add more fragments 245 to each of the objects 105 remaining. Otherwise, if the set top box manager 345 in step 930 determines that the line conditions or other factors merit better than normal conditions, then the set top box manager 345 in step 940 instructs the set top box 320 to remove excess fragments 245 from each object 105 and instructs the distribution server 310 to send additional lead portions 110 of objects 105. After dynamically updating the lead portions 110, the set top box 345 in step 945 repeats the line analysis and jumps to step 925 to repeat computations for dynamic cache updating.

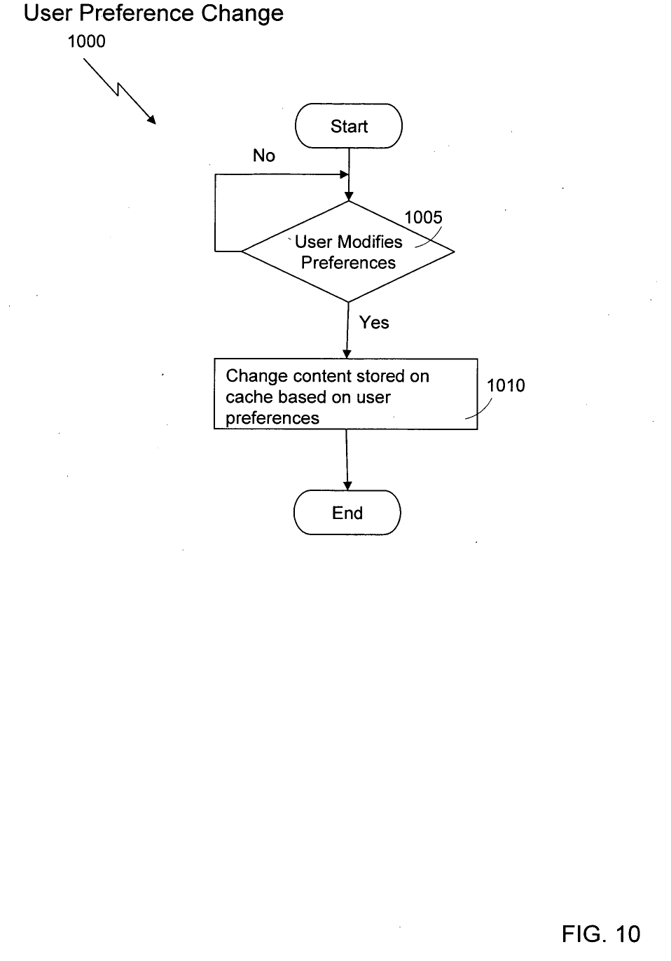

FIG. 10 is a flowchart illustrating a method 1000 of modifying objects stored based on a user preference change. Method 1000 begins with the set top box 320 in step 1005 waiting until a user requests a change in user preferences. When a change request is received, the set top box 320 in step 1010 informs the set top box manager 345, which computes the corresponding list of objects 105 to make available to the set top box 320, and instructs the distribution server 310 to effect the changes (and updates the subscriber database 355 to reflect the changes). Method 1000 then ends.

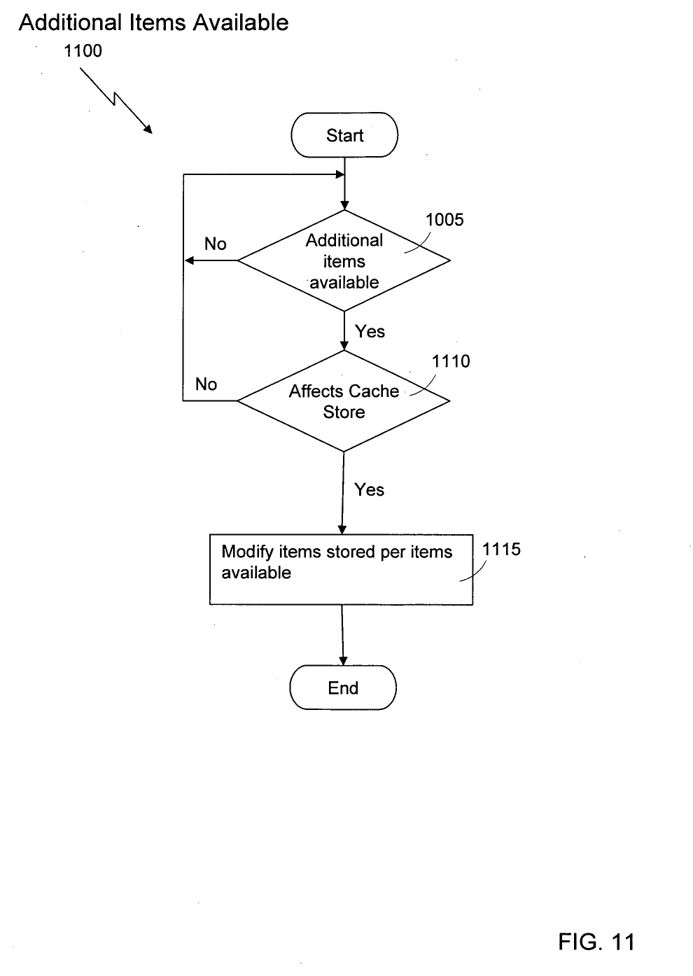

FIG. 11 is a flowchart illustrating a method 1100 of modifying objects 105 stored based on additional objects 105 becoming available. Method 1000 begins with the set top box manager 345 waiting until it receives notice from the content library 305 of a change (addition, subtraction, version addition, version subtraction, etc.) of the objects 105 currently available in the content library 305. The set top box manager 345 in step 1110 (either continually, at predetermined times, after a predetermined number of changes and/or additions, upon satisfaction of certain criteria, etc.) computes whether the change affects the contents of each cache store (e.g., the selection or size of the lead portions 110 in each storage device 425). Determining whether the change affects the cache store may include user preference analysis, the popularity or likelihood a user would select the object 105 (e.g., Academy Award winner, etc.), etc. If the change would not affect the cache store, then the method 1100 returns to step 1105. Otherwise, if the change would affect the cache store, then the set top box manager 345 in step 1115 instructs the set top box 320 to delete certain lead portions 110 of objects 104, instructs the distribution server 310 to send additional lead portions 110 of objects 105 to the set top box 320, effects dynamic cache updating, etc.

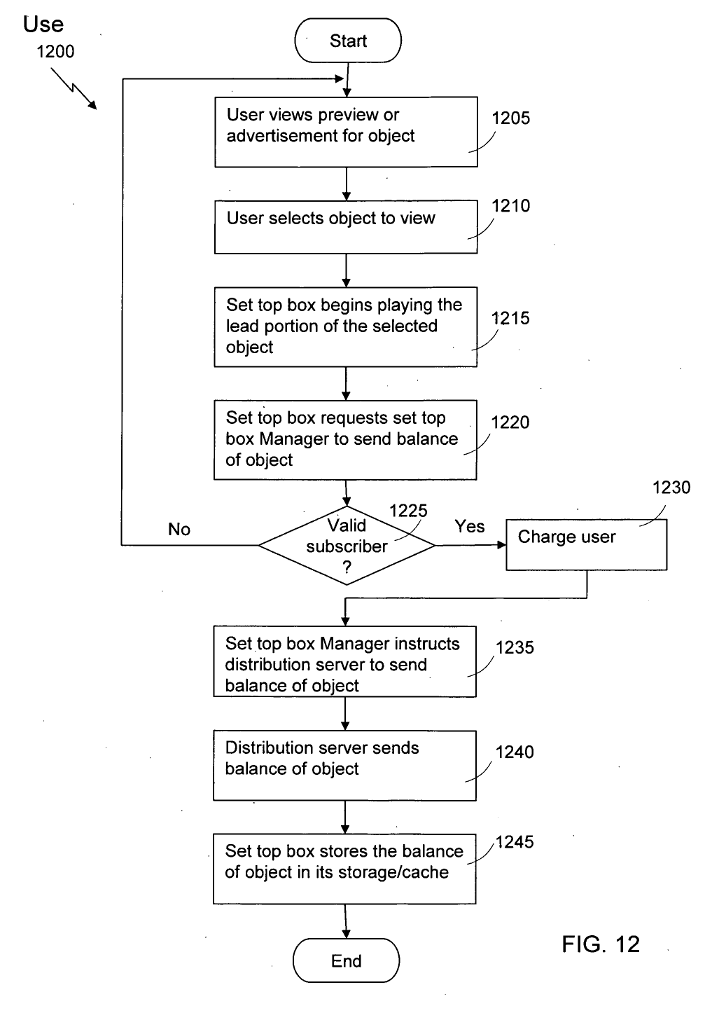

FIG. 12 is a flowchart illustrating a method 1200 of using an object partitioning and distribution system 300, in accordance with an embodiment of the present invention. Method 1200 begins with the user in step 1205 using the set top box 320 to consume a preview, an advertisement, a content list, etc. for an object 105. The user in step 1210 uses a user interface to select an object 105 for consumption. The set top box 320 in step 1215 initiates user consumption (e.g., playback) of the lead portion 110 of the object previously loaded on the set top box 320. The set to box 320 in step 1220 requests the set top box manager 345 to send the balance portion 115 of the object 105 to the set top box 320. The set top box manager 345 in step 1225 uses subscriber database 355 to determine if the set top box 320 is requesting a valid operation. If not, then method 1200 returns to step 1205. Otherwise, if authorized, then the set top box manager 345 in step 1230 uses the billing system 350 to bill the user according to the user's subscription, preferences, etc. The set top box manager 345 in step 1235 instructs the distribution server 310 to send the balance portion 115 of the object 105. The distribution server 310 in step 1240 sends the balance portion 115 of the object 105 to the set top box 320, preferably using narrowcast communication channels 335. The set top box 320 stores the incoming stream to the storage device 425 for consumption in due course. Method 1200 then ends.

Although the embodiments above describe the lead portions 110 as stored in the set top box 320, one skilled in the art will recognize that the lead portions 110 can be stored in other locations, such as at the “edge” of a network proximate to the set top box 320 and downloaded either during or before consumption. The edge of the network includes within an internet service provider, DSLAM or dedicated “lead” server (not shown) servicing the broadband connection for the set top box 320 and preferably geographically proximate to the set top box 320. In this embodiment, a method comprises storing a lead portion 110 of an object 105 on a first server prior to receiving a request for consumption of the object 105, the first server being geographically proximate to a set top box 320; storing a balance portion 115 of an object 105 on at least one second server (e.g., the content library 305); receiving a request for consumption of the object 105 by the set top box 320; requesting the lead portion 110 to be forwarded from the first server to the set top box 320; initiating consumption of the lead portion 110; and receiving at least some of a balance portion 115 of the object 105 during consumption of the object 105. In another embodiment, a method which may be performed by the set top box manager 345 comprises storing an object 105; forwarding a lead portion 110 of the object 105 to a first server, the first server being geographically proximate to a set top box 320; receiving a request from the set top box 320 for a balance portion 115 of the object 105, the request received after the lead portion 110 has been forwarded to the first server; and forwarding the balance portion 115 to the set top box 320. The lead portion 110 may be forwarded to the set top box 320 via a request to the first server or a request to the set top box manager 345. The lead portion 110 may be streamed from the first server during consumption or downloaded first before consumption. In either case, the size of the lead portion 110, the number of previews to initiate first, the wait time, etc. will be based on the teachings discussed above, including communication channel conditions, object size, object popularity, final bit lead time, etc.

The foregoing description of the preferred embodiments of the present invention is by way of example only, and other variations and modifications of the above-described embodiments and methods are possible in light of the foregoing teaching. For example, although the network system 300 is shown as not including peer-to-peer networking, one skilled in the art will recognize that object 105 portions can be stored on and streamed from peer systems or set top boxes 320. Also, although the embodiments are described such that the balance portion 115 is a single portion stored in a single location, one skilled in the art will recognize that the balance portion 115 can be distributed in many locations, can be controlled by devices other than the set top box manager 345, etc. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
storing a lead portion of an object on a set top box prior to receiving a request for consumption of the object;
receiving a request for consumption of the object;
initiating consumption of the lead portion; and
receiving at least some of a balance portion of the object during consumption of the object.

2. The method of claim 1, wherein the object includes video.

3. The method of claim 1, wherein the object includes an electronic game.

4. The method of claim 1, wherein the object includes pure audio.

5. The method of claim 1, wherein the object includes text.

6. The method of claim 1, wherein the size of the lead portion is computed periodically to reduce likelihood of consumption interruption.

7. The method of claim 1, wherein the size of the lead portion is computed based on communication channel conditions.

8. The method of claim 7, wherein the size of the lead portion is computed based on the worst case channel condition over a predetermined window of time.

9. The method of claim 1, wherein the size of the lead portion is computed by an algorithm accounting for download speed, object size, and playback time.

10. The method of claim 1, wherein the size of the lead portion is computed so that the final bit of the balance portion of the object is expected to be received before the final bit is needed for consumption.

11. The method of claim 1, wherein the size of the lead portion is computed based on object popularity.

12. The method of claim 1, wherein the size of the lead portion is increased based on the expected demand of the object.

13. The method of claim 1, further comprising storing other lead portions of many other objects.

14. A set top box, comprising:
storage storing a lead portion of an object prior to receiving a request for consumption of the object;
a user interface for receiving a request for consumption of the object;
a communication interface for communicating with a remote device, the remote device initiating delivery of a balance portion of the object upon request; and
a control module coupled to the storage device, to the user interface and to the communication interface for initiating consumption of the lead portion, for requesting delivery of the balance portion, and for receiving at least part of the balance portion of the object during consumption of the object.

15. The set top box of claim 14, wherein the object includes video.

16. The set top box of claim 14, wherein the object includes an electronic game.

17. The set top box of claim 14, wherein the object includes pure audio.

18. The set top box of claim 14, wherein the object includes text.

19. The set top box of claim 14, wherein the size of the lead portion is computed periodically to reduce likelihood of consumption interruption.

20. The set top box of claim 14, wherein the size of the lead portion is computed based on communication channel conditions.

21. The set top box of claim 20, wherein the size of the lead portion is computed based on the worst case channel condition over a predetermined window of time.

22. The set top box of claim 14, wherein the size of the lead portion is computed by an algorithm accounting for download speed, object size, and playback time.

23. The set top box of claim 14, wherein the size of the lead portion is computed so that the final bit of the balance portion of the object is expected to be received before the final bit is needed for consumption.

24. The set top box of claim 14, wherein the size of the lead portion is computed based on object popularity.

25. The set top box of claim 14, wherein the size of the lead portion is increased based on the expected demand of the object.

26. The set top box of claim 14, wherein the storage stores other lead portions of many other objects.

27. A method, comprising:
storing an object;
forwarding a lead portion of the object to a set top box;
receiving a request for a balance portion of the object, the request received after the lead portion has been forwarded to the set top box; and
forwarding the balance portion to the set top box.

28. The method of claim 27, wherein the object includes video.

29. The method of claim 27, wherein the object includes an electronic game.

30. The method of claim 27, wherein the object includes pure audio.

31. The method of claim 27, wherein the object includes text.

32. The method of claim 27, wherein the size of the lead portion is computed periodically to reduce likelihood of consumption interruption.

33. The method of claim 27, wherein the size of the lead portion is computed based on communication channel conditions.

34. The method of claim 33, wherein the size of the lead portion is computed based on the worst case channel condition over a predetermined window of time.

35. The method of claim 27, wherein the size of the lead portion is computed by an algorithm accounting for download speed, object size, and playback time.

36. The method of claim 27, wherein the size of the lead portion is computed so that the final bit of the balance portion of the object is expected to be received before the final bit is needed for consumption.

37. The method of claim 27, wherein the size of the lead portion is computed based on object popularity.

38. The method of claim 27, wherein the size of the lead portion is increased based on the expected demand of the object.

39. The method of claim 27, further comprising storing many other objects.

40. The method of claim 27, wherein the step of forwarding the balance portion includes streaming the balance portion.

41. A system, comprising:
storage storing an object; and
a distribution server for forwarding a lead portion of the object to a set top box, and for forwarding a balance portion of the object to the set top box after the lead portion has been forwarded to the set top box and after receiving a request from the set top box.

42. The system of claim 41, wherein the object includes video.

43. The system of claim 41, wherein the object includes an electronic game.

44. The system of claim 41, wherein the object includes pure audio.

45. The system of claim 41, wherein the object includes text.

46. The system of claim 41, wherein the size of the lead portion is computed periodically to reduce likelihood of consumption interruption.

47. The system of claim 41, wherein the size of the lead portion is computed based on communication channel conditions.

48. The system of claim 47, wherein the size of the lead portion is computed based on the worst case channel condition over a predetermined window of time.

49. The system of claim 41, wherein the size of the lead portion is computed by an algorithm accounting for download speed, object size, and playback time.

50. The system of claim 41, wherein the size of the lead portion is computed so that the final bit of the balance portion of the object is expected to be received before the final bit is needed for consumption.

51. The system of claim 41, wherein the size of the lead portion is computed based on object popularity.

52. The system of claim 41, wherein the size of the lead portion is increased based on the expected demand of the object.

53. The system of claim 41, further comprising storing many other objects.

54. The system of claim 41, wherein the distribution server forwards the balance portion by streaming the balance portion.

55. A system, comprising:
means for storing a lead portion of an object on a set top box prior to receiving a request for consumption of the object;
means for receiving a request for consumption of the object;
means for initiating consumption of the lead portion; and
means for receiving at least some of a balance portion of the object during consumption of the object.

56. A system, comprising:
means for storing an object;
means for forwarding a lead portion of the object to a set top box;
means for receiving a request for a balance portion of the object, the request received after the lead portion has been forwarded to the set top box; and
means for forwarding the balance portion to the set top box.

57. A method comprising:
storing a lead portion of an object on a first server prior to receiving a request for consumption of the object, the first server being geographically proximate to a set top box;
storing a balance portion of an object on at least one second server;
receiving a request for consumption of the object by the set top box;
requesting the lead portion to be forwarded from the first server to the set top box;
initiating consumption of the lead portion; and
receiving at least some of a balance portion of the object during consumption of the object.

58. A method, comprising:
storing an object;
forwarding a lead portion of the object to a first server, the first server being geographically proximate to a set top box;
receiving a request from the set top box for a balance portion of the object, the request received after the lead portion has been forwarded to the first server; and
forwarding the balance portion to the set top box.
